(19) United States
(12) Patent Application Publication
(10) Pub. No.: US 2005/0003965 A1
(43) Pub. Date: Jan. 6, 2005

(54) Hydraulic fracturing method

(76) Inventors: Zhijun Xiao, Kuala Lumpur (MY); Mathew Samuel, Al-Khobar (SA); Raymond Joseph Tibbles, Fort Collins, CO (US); Omar Moussa, Kuala Lumpur (MY)

Correspondence Address: SCHLUMBERGER TECHNOLOGY CORPORATION, IP DEPT., WELL STIMULATION, 110 SCHLUMBERGER DRIVE, MD1, SUGAR LAND, TX, 77478, US

(21) Appl. No.: 10/611,766

(22) Filed: Jul. 1, 2003

(51) Int. Cl. C09K 7/02

(52) U.S. Cl. 507/100

(57) ABSTRACT

The invention relates to a method of fracturing a subterranean formation at reduced surface pressure including injecting into a wellbore an energized fracturing fluid based on a liquid medium having a density higher than 1.2 g/cm³.

### TECHNICAL FIELD OF THE INVENTION

This invention relates generally to the art of hydraulic fracturing in subterranean formations and more particularly to a method and means for optimizing fracture treatment.

### BACKGROUND OF THE INVENTION

Hydrocarbons (oil, natural gas, etc.) are obtained from a subterranean geological formation (i.e., a “reservoir”) by drilling a well that penetrates the hydrocarbon-bearing formation. This provides a partial flowpath for the hydrocarbon to reach the surface. In order for the hydrocarbon to be “produced,” that is travel from the formation to the wellbore (and ultimately to the surface), there must be a sufficiently unimpeded flowpath from the formation to the wellbore.

Hydraulic fracturing is a primary tool for improving well productivity by placing or extending channels from the wellbore to the reservoir. This operation is essentially performed by hydraulically injecting a fracturing fluid into a wellbore penetrating a subterranean formation and forcing the fracturing fluid against the formation strata by pressure. The formation strata or rock is forced to crack and fracture. Proppant is placed in the fracture to prevent the fracture from closing and thus, provide improved flow of the recoverable fluid, i.e., oil, gas or water.

Hydraulic fracturing for well stimulation relies on the ability to pump the fracturing fluid at a bottomhole pressure sufficient to overcome the formation in-situ stresses so that the rock can be cracked. Once a fracture is initiated, enough bottomhole pressure must be maintained to propagate the fracture further away from the wellbore and generate the necessary fracture width for it to be filled with the propping material that will keep the fracture open once the pumping has stopped. The initial breakdown pressure is usually higher than the minimum pressure needed to re-open the same fracture. This is due to the tectonic stress in the rock that has to be initially overcome. The minimum pressure needed to re-open the fracture after breakdown is called the fracture opening pressure. This pressure is usually slightly higher than the fracture closure pressure due to poroelastic effects and other factors due to the geologic setting. The fracture closure pressure is the pressure at which the fracture will close. Therefore, after the fracture is re-opened, the bottomhole pressure or BHP needs to be above the fracture closure pressure to successfully perform the fracturing treatment.

The effective bottomhole pressure is the sum of the surface pressure provided by the pumping equipment and the hydrostatic pressure, minus the pressure losses due to friction forces while the fluid passes through the surface and subterranean equipments such as pipes. The required bottomhole pressure is governed by the mechanical properties of the formation and is therefore an intangible parameter. To match the required and effective bottomhole pressure, the focus shall be on either increasing the surface pressure and/or the hydrostatic pressure or lowering the friction pressures.

The maximum surface pressure may be the limitation of the service company pumping equipment and may be increased by either using different pumps with a higher pressure capacity. Increasing the numbers of pumps, or utilization of pumps with a higher hydraulic horsepower (HHP) rating, is needed if the limitation is the amount of HHP needed to pump the fracturing treatment. Obviously, this results in increased cost, not only equipment but also logistic and personal costs. Moreover, this option may simply not be available for instance on an offshore rigs. Regardless of the cost and availability of the equipment, an increased of the surface pressure may be also ruled out by the surface and/or subterranean equipment. This is because the surface pressure is also limited based on the “weakest point” in the completion of the well, consisting of surface equipment for instance such as blowout preventers, valves, tree-savers; casing and tubing properties (size, weight and grade), packers, etc.

Lowering the friction pressure is a main focus of the well services industry and also involves early planning during the well construction by increasing the size (internal diameter) of the tubing or casing. Other fracturing designs options include pumping the fracturing fluid down the annulus instead of the smaller tubing, using lower pumping rates or maximizing the drag reduction properties of the fluid by adding friction reducer or delaying the crosslink time for polymer-based fluids for instance. Though dramatic progresses have been done in that area in recent years, there is a limit to the reduction that can be achieved that way since the friction pressure cannot be annihilated.

As mentioned above, the required bottomhole pressure is governed by the mechanical properties of the formation. In general, but not always, the deeper the well, the higher the needed bottomhole pressure. As a rule of thumb, a bottomhole pressure of 0.75 psi is required by foot of depth (or in order words, about 17 kPa/m). With a focus towards deeper wells for low permeability gas field development, and towards wells in deep water where friction pressure accounts for a larger part of the surface treating pressure, there is therefore a remaining need for fracturing processes that will allow achieving higher bottomhole pressure while keeping relatively low surface pressure.

Particularly high pumping pressures may be required for foamed systems where the hydrostatic pressure is low due to the presence of gas. Foamed systems include foam or and energized fluids and are stable mixture of gas and liquid, which are mainly used in fracturing low pressure or water sensitive formations. Foam and energized fracturing fluids are generally described by their foam quality, i.e. the ratio of gas volume to the foam volume. If the foam quality is between 52% and 95%, the fluid is usually called foam. Above 95%, a foam is generally changed to mist. Stable dispersion of gas in liquid with foam quality less than 52% is called energized fluid. In the present patent application, the term “foamed system” will be used however to describe any stable mixture of gas and liquid, whatever the foam quality is. The foam half-life is another important parameter to evaluate the stability of foam or energized fluids. The half life of a foam or energized fluids is the time necessary for one-half of the liquid used to generate the foam to break out of the foam under atmospheric conditions.

Foam systems however present numerous advantages. They expand when they flow back from the well and therefore force the fluid out of the fracture, consequently ensuring a superior clean-up. They typically require less viscosifying agent while presenting good fluid loss control and fluid efficiency. As a result, foamed systems are often cheaper than conventional systems unless the cost benefit due to the use of lower quantities of chemicals is overturned by the need of higher horse power, and consequently of specific pumping equipment.

### SUMMARY OF THE INVENTION

According to a first aspect of the present invention, a method of fracturing a subterranean formation is proposed that includes injecting into a wellbore a foamed fracturing fluid based on a liquid medium having a density higher than 1.2 g/cm³, thereby allowing the use of a surface pressure at least 10% smaller than the surface pressure required with a foamed fracturing fluid based on a liquid medium having a density of about 1 g/cm³.

The method of the invention is particularly useful for fracturing wells that require high bottomhole pressure at least during part of the treatment and makes possible the stimulation of wells previously eliminated as candidates due to surface pressure restrictions. In particular, the invention allows the use of standard equipment, that have an upper limit of typically about 15,000 psi or even of standard coiled tubing pumping unit that have an upper limit of typically about 7,000 psi.

Such a high density is obtained for instance by preparing the liquid phase of the foam fluids with a viscoelastic surfactant compatible with high concentrations and or densities of salts, preferably such as a zwitterionic surfactant. The surfactant is not only used to viscosify the liquid phase of the foam fluids, but also used as a foaming agent to create and stabilize the foam.

Zwitterionic surfactants suitable for carrying out the method of the present invention include mixture of amphoteric/zwitterionic surfactants and an organic acid, salt and/or inorganic salt as it is known from International Patent Publication WO 98/56497. The surfactants are for instance dihydroxyl alkyl glycinate, alkyl ampho acetate or propionate, alkyl betaine, alkyl amidopropyl betaine and alkylamino mono- or di-propionates derived from certain waxes, fats and oils. The surfactants are used in conjunction with an inorganic water-soluble salt or organic additives such as phthalic acid, salicylic acid or their salts. Amphoteric/zwitterionic surfactants, in particular those comprising a betaine moiety are useful at temperature up to about 150° C. and are therefore of particular interest for medium to high temperature wells.

According to one embodiment of the invention, the method of fracturing involves the use of a betaine that contains an oleyl acid amide group (including a C₁₇H₃₃ alkene tail group).

Yet a preferred embodiment of the present invention is a method of fracturing subterranean formation while maintaining lower surface pressure involving the use of a betaine that contains an erucic acid amide group (including a C₂₁H₄₁ alkene tail group). The surfactant may be further stabilized by the addition of an alcohol, and preferably methanol.

To be noted that to alleviate the inconvenient of low hydrostatic pressure, it is often proposed to use carbon dioxide as gas phase. However, carbon dioxide leads to the formation of calcium carbonate that may precipitate. Moreover, carbon dioxide is more expansive than nitrogen, raises security issues and is not compatible with highly basic systems. The invention expands the range of use of nitrogen, while being compatible with the use of carbon dioxide when further increase of the hydrostatic pressure is suitable.

### BRIEF DESCRIPTION OF THE DRAWINGS

The above and further objects, features and advantages of the present invention will be better understood by reference to the appended detailed description, and to the drawings wherein:

FIG. 1 is the plot of overall hydrostatic pressure gradient versus liquid phase density of a typical foam fracturing fluid;

### DETAILED DESCRIPTION AND PREFERRED EMBODIMENTS

In most cases, a hydraulic fracturing treatment consists in pumping a proppant-free viscous fluid, or pad, usually water with some high viscosity fluid additives, into a well faster than the fluid can escape into the formation so that the pressure rises and the rock breaks, creating artificial fracture and/or enlarging existing fracture. Then, a propping agent such as sand is added to the fluid to form a slurry that is pumped into the fracture to prevent it from closing when the pumping pressure is released. The proppant transport ability of a base fluid depends on the type of viscosifying additives added to the water base, on the density difference between the proppant and the water base carrier fluid and on the velocity of the slurry in the hydraulic fracture.

The downhole pressure required to crack the subterranean formation is function of the surface pressure, the weight of the hydraulic column (the hydrostatic pressure) and is reduced by the pressure losses due in particular to the tubing and other downhole equipment frictions and to the perforation friction pressure. In the key initial stage of fracturing, the pumped fracturing fluid is proppant-free, and therefore the hydrostatic pressure is not enhanced by the weight of the proppant, typically consisting of sand or ceramic particles.

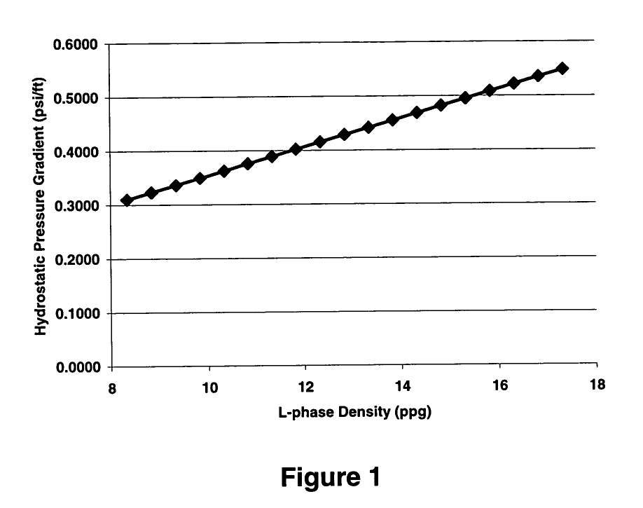

For foam fracturing treatment, the overall hydrostatic pressure is contributed by hydrostatic pressure from both liquid and gas phases. An increase of the liquid phase density results in an increase of liquid hydrostatic pressure and further results in an increase of the overall hydrostatic pressure and downhole pressure available for fracturing the formation without the need to increase the surface pressure. For a typical case listed in table 1, FIG. 1 shows us the relationship between overall hydrostatic pressure and the density of the foam liquid phase.

TABLE 1

| Parameter | Unit | Value |
|---|---|---|
| Frac Gradient | psi/ft | 0.75 |
| Vertical Depth | ft | 15000 |
| Liquid Ratio | decimal | 0.5 |
| Gas Ratio | decimal | 0.5 |
| Geothermal Gradient | degree F/100 ft | 2 |
| Bottomhole Pressure | psi | 11250 |
| Wellhead Pressure | psi | 8600 |

Nature of high density of foamed fluids invented provides high hydrostatic head for the fracturing operation. Horsepower will be accordingly saved by this property compared to other polymeric or VES foamed fracturing fluids. Table 2 shows that the present invention allows horsepower savings of more than 10%. Meanwhile, 8.34 ppg fluid cannot be used in this example case due to the high friction from tubing and perforation, resulting in high standard of surface pumping pressure. The use of 12.4 ppg foamed fluid according to this invention reduces the surface pressure by 11%, making it possible to successfully fracture the well.

TABLE 2

| | | | | |
|---|---|---|---|---|
| Liquid Phase | ppg | 8.34 | 12.34 | 16.34 |
| Density | | | | |
| Frac Gradient | psi/ft | 0.75 | 0.75 | 0.75 |
| Vertical Depth | ft | 15000 | 15000 | 15000 |
| Liquid Ratio | decimal | 0.5 | 0.5 | 0.5 |
| Gas Ratio | decimal | 0.5 | 0.5 | 0.5 |
| Geothermal | degree F/100 ft | 2 | 2 | 2 |
| Gradient | | | | |
| Bottomhole Pressure | psi | 11250 | 11250 | 11250 |
| Wellhead Pressure | psi | 8600 | 8600 | 8600 |
| Friction pressure | psi | 9000 | 9000 | 9000 |
| (tubing + perf) | | | | |
| Overall Hydrostatic | psi | 4644 | 6236 | 7827 |
| Pressure | | | | |
| Surface Pumping | psi | 15606 | 14014 | 12423 |
| Pressure | | | | |
| Pump Rate | BPM | 25 | 25 | 25 |
| Surface HHP | HHP | 9558 | 8583 | 7609 |
| HHP Savings | % | | 11% | 20% |

Since the first foam fracturing application in the mid-1970's , water soluble polymers, such as guar gums, high-molecular weight polysaccharides composed of mannose and galactose sugars, or guar derivatives such as hydropropyl guar (HPG), carboxymethylhydropropyl guar (CMHPG), are mainly used to prepare the liquid phase of the foam fluids. Crosslinking agents based on boron, titanium, zirconium or aluminum complexes are typically used to increase the effective molecular weight of the polymer and make them better suited for use in high-temperature wells.

Xanthan gum has been shown to have excellent proppant-suspension ability as well as foam stabilizing capacity even though they are more expensive than guar derivatives and therefore used less frequently.

Though some attempts have been made in the past (see for instance U.S. Pat. Nos. 5,785,747 and 6,100,222), high-density brines comprising above water-soluble polymers, which could be potentially used for the preparation of foam fluid liquid phase, are typically not practicable due to adverse effect of brines on polymer hydration and foam stability.

Polymer-free, liquid phase of foam fluids can be obtained using viscoelastic surfactants. These fluids are normally prepared by mixing in appropriate amounts suitable surfactants such as anionic, cationic, nonionic and zwitterionic surfactants in aqueous solutions. The viscosity of viscoelastic surfactant fluids is attributed to the three dimensional structure formed by the components in the fluids. When the concentration of surfactants in a viscoelastic fluid significantly exceeds a critical concentration, and in most cases in the presence of an electrolyte, surfactant molecules aggregate into species such as micelles, which can interact to form a network exhibiting viscosity and elastic behavior to further stabilize the foamed systems. Meanwhile, the surfactant also acts as foaming agent to create the stable dispersion of gas in viscous liquid

Cationic viscoelastic surfactants—typically consisting of long-chain quaternary ammonium salts such as cetyltrimethylammonium bromide (CTAB)—have been so far of primarily commercial interest in above applications. Common reagents that generate viscoelasticity in the surfactant solutions are salts such as ammonium chloride, potassium chloride, sodium chloride, sodium salicylate and sodium isocyanate and non-ionic organic molecules such as chloroform. The electrolyte content of surfactant solutions is also an important control on their viscoelastic behavior. Reference is made for example to U.S. Pat. No. 4,695,389, U.S. Pat. No. 4,725,372, U.S. Pat. No. 5,551,516, U.S. Pat. No 5,964,295, and U.S. Pat. No. 5,979,557. However, fluids comprising this type of cationic viscoelastic surfactants usually tend to lose viscosity at high brine concentration (10 pounds per gallon or more) and may be unstable in presence of divalent salts such as calcium bromide or calcium chloride. Therefore, these fluids have seen limited use as high density liquid phase of the foam fracturing fluids or in other applications requiring heavy fluids to balance well pressure or to minimize surface treating pressure.

It is also known from International Patent Publication WO 98/56497, to impart viscoelastic properties using amphoteric/zwitterionic surfactants and an organic acid, salt and/or inorganic salt. The surfactants are for instance dihydroxyl alkyl glycinate, alkyl ampho acetate or propionate, alkyl betaine, alkyl amidopropyl betaine and alkylamino mono- or di-propionates derived from certain waxes, fats and oils. The surfactants are used in conjunction with an inorganic water-soluble salt or organic additives such as phthalic acid, salicylic acid or their salts. Amphoteric/ zwitterionic surfactants, in particular those comprising a betaine moiety are useful at temperature up to about 175° C. and are therefore of particular interest for medium to high temperature wells. However, like the cationic viscoelastic surfactants mentioned above, in absence of co-additive, they are usually not compatible with high brine concentration.

Some betaine surfactants are particularly useful in forming aqueous gels of exceptional thermal stability in any electrolyte concentration as well as in forming a stable foams with no added salt or even in heavy brines. Their compatibility with heavy brines at unexpectedly high temperatures is an important feature of the present invention. Two preferred examples are betaines called, respectively, BET-O and BET-E. The surfactant BET-O-30 is shown below and may be obtained from Rhodia, Inc. Cranbury, N.J., U.S.A. The O indicates that it contains an oleyl acid amide group (including a C₁₇H₃₃ alkene tail group) and the 30 indicia refers to a concentration of active surfactant of about 30%; the remainder being substantially water, sodium chloride, and propylene glycol. An analogous material, BET-E-40, is also available from Rhodia, contains a erucic acid amide group (including a C₂₁H₄₁ alkene tail group) and is 40% active ingredient, with the remainder substantially water, sodium chloride, and isopropanol. The surfactant in BET-E-40 is also shown below. BET surfactants, and others, are described in U.S. Pat. No. 6,258,859. According to that patent, cosurfactants may be useful in extending the brine tolerance, and to increase the gel strength and to reduce the shear sensitivity of the VES-fluid, especially for BET-O. An example given in U.S. Pat. No. 6,258,859 is sodium dodecylbenzene sulfonate (SDBS). Other suitable cosurfactants for BET-O-30 are certain chelating agents such as trisodium hydroxyethylethylenediamine-triacetate.

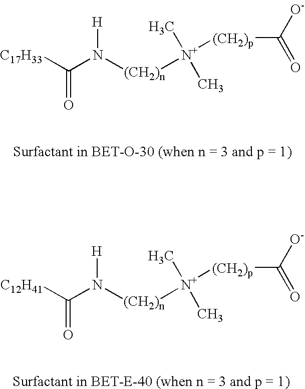

As shown in FIGS. 2 to 4, with BET-E, high-density brine can be made from metal halide (KCl, CaBr₂, CaCl₂, ZnBr₂ . . . etc), chelants (EDTA, EDTA metal salts . . . etc), sequesters (phosphates, polyphosphates . . . etc), other inorganic metal salts like K₂CO₃, K₂SO₄ . . . and organic salts such as formates and acetates.

Proppant carrying capacity of foam fluids is contributed by both liquid phase and foam structures. An increase of the density of the liquid phase leads to better proppant suspension since the proppant settling velocity in liquid phase of the foam fluids is generally proportional to the density difference of the proppant and liquid phase. As described by Novotny equation, proppant settling in a power-law fluid is
Uₛₒₗ=(1−fᵥ)^{β}[(ρₛₒₗ−ρ_{f})gdⁿ⁺¹/(3ⁿ⁻¹18K′)]^{1/n}
Where: β=proppant settling velocity
fᵥ=volume fraction of proppant
ρₛₒₗ=proppant density
ρ_{f}=fluid density
n, K′=power law parameters
d=proppant particle diameter

Assuming same parameters of β, fᵥ, n, K′ and d, we will have Uₛₒₗ∝(ρₛₒₗ−ρ_{f})^{1/n}. For a case of 3.0 SG proppant and n=0.5 fluid, relationship of proppant settling velocity in fluids with different densities is calculated in table 3.

TABLE 3

| | |
|---|---|
| Proppant Density | 3.0 g/cc |
| Fluid density | 8.3 ppg and 14.0 ppg |
| n | 0.5 |
| Settling velocity in 14.0 ppg/settling | 0.4324 |
| velocity in 8.3 ppg | |

From above calculation, proppant settling velocity in high density foam fracturing fluid of this invention is much lower than that in traditional polymeric foamed fracturing fluids.

An additional requirement for foam fluids is there ability to be stable and not to segregate into different phases or layers. From that point of view, foamed fracturing fluids whose liquid phase and foaming agent prepared with BET-E are particularly interesting. Table 4 below list the rheology comparison between different energized fluids at 26° C. 26 C.

TABLE 4

| | Foam | Viscosity (cp) | | |
|---|---|---|---|---|
| Base fluid | quality | 40 sec-1 | 170 sec-1 | 511 sec-1 |
| Linear Guar in 2% KCl | 52% | 85 | 48 | — |
| water at 20 pounds | | | | |
| per 1000 gallons | | | | |
| Crosslinked guar in 2% KCl | 52% | — | 68 | 34 |
| water at 20 pound | | | | |
| per 1000 gallons | | | | |
| 1.5% Cationic surfactant in | 52% | — | 120 | — |
| 3% NH4Cl water | | | | |
| 10% BET-E in 40% CaCl₂ | 52% | — | 144 | 91 |
| brine | | | | |

Table 5 shows the viscosity at 100 sec-1 (in cP) of the foam fluid with 10% BET-E in 40% calcium chloride brine at 450 psi pressure and different temperatures.

TABLE 5

| Temperature (F) | n′ | k′ | Viscosity at 100 sec-1 (cp) |
|---|---|---|---|
| 26.7° C. | 0.4467 | 0.0753 | 282 |
| 37.7° C. | 0.1779 | 0.4700 | 511 |
| 51.7° C. | 0.1422 | 0.7123 | 656 |
| 65.5° C. | 0.1254 | 1.1230 | 958 |
| 79.4° C. | 0.2299 | 0.8379 | 1156 |
| 93.3° C. | 0.5274 | 0.2077 | 1128 |
| 107.2° C. | 0.1029 | 0.6077 | 467 |
| 121.1° C. | 0.2281 | 0.3903 | 534 |
| 135° C. | 0.6598 | 0.0465 | 465 |
| 148.9° C. | 0.9503 | 0.0070 | 268 |
| 162.8° C. | 1.1219 | 0.0014 | 115 |
| 176.7° C. | 1.2467 | 0.0002 | 34 |

Above rheology data listed in tables 4 and 5 indicate that foamed fracturing fluids prepared in heavy brines of this invention have much better viscosity than normal polymeric or other surfactant foamed fluids regarding to the foam stability, fluid loss control and proppant suspension capacities.

Table 6 compares the foam half-life of different foam fluids, all measurements were performed at 93.3° C.

TABLE 6

| | Foam | | |
|---|---|---|---|
| | qual- | | |
| Fluids | ity | Formula | Half Life |
| Linear Guar | 70% | 0.5% foaming agent and | 6 minutes |
| | | 20 ppt guar in | |
| | | 2% KCl water | |
| Cationic surfactant | 70% | 4% J508W in 3% NH4Cl | 10 minutes |
| BET-E in CaCl₂ brine | 60% | 5% BET-E in 20% CaCl₂ | 270 minutes |
| BET-E in CaCl₂ brine | 60% | 5% BET-E in 16% CaCl₂ | >240 minutes |
| BET-E in CaCl₂ brine | 60% | 5% BET-E in 32% CaCl₂ | >280 minutes |
| BET-E in CaCl₂ brine | 60% | 5% BET-E in 4% CaCl₂ | <100 minutes |
| BET-E in CaCl₂ brine | 60% | 5% BET-E in 8% CaCl₂ | <120 minutes |

After 4 hours at 93.3° C, a foam comprising 5% BET-E and 16% calcium chloride is still stable. Increasing the amount of calcium chloride to 32% provides even better stability. Initial weight and final weight was measured after static aging, No weight change was observed. However, samples prepared with only 4% or 8% of calcium chloride show the formation of a water layer under the foam after 2 hours.

Table 7 lists fluid properties of two energized fracturing fluids particularly suitable for carrying out the present invention. The systems are stable for longer than 90 minutes even at temperatures above 275 F and about 100 psi pressure.

TABLE 7

| | Fluids | |
|---|---|---|
| | I | II |
| Formula | 5% BET-E + 36% CaCl₂ | 10% BET-E + 36% CaCl₂ |
| Foam Quality | 50% | 40% |
| Temperature (F) | 275 F | 300 F |
| Half Life at | 150 minutes | 85 minutes |
| temperature | | |

Data listed in tables 6 and 7 indicate that foamed fluids of this invention have much better foam stability in heavy brines than traditional polymeric or cationic surfactant foamed fluids.

1. A method of fracturing a subterranean formation at reduced surface pressure including injecting into a wellbore an energized fracturing fluid based on a liquid medium having a density higher than 1.2 g/cm³.

2. The method of claim 1, wherein the liquid medium has a density greater than 1.5 g/cm³.

3. The method of claim 1, wherein the energizing gas is selected from the group consisting of nitrogen, carbon dioxide, air and mixture thereof.

4. The method of claim 1, wherein the energized fracturing fluid has a foam quality of at least 25%.

5. The method of claim 1, wherein the energized fracturing fluid has a foam quality of at least 50%.

6. The method of claim 1, wherein the liquid medium comprises an aqueous solution, a zwitterionic surfactant as gelling agent and salts.

7. The method of claim 6, wherein said zwitterionic surfactant is a betaine containing an erucic acid amide group.

8. The method of claim 6, wherein said zwitterionic surfactant is a betaine containing a oleyl acid amide group.

9. The method of claim 1, wherein the fluid comprises at least a density-enhancer selected from the group consisting of salts, sugar, chloroform, carbon tetrachloride and glycerol and mixture therof.

10. The method of claim 9, wherein said density enhancer is a salt selected from the group consisting of calcium chloride, calcium bromide, potassium bromide, sodium bromide and mixture thereof.
